(19) United States
(12) Patent Application Publication
(10) Pub. No.: US 2009/0241613 A1
(43) Pub. Date: Oct. 1, 2009

(54) DIRECT CONNECTING TYPE DOOR LATCH DEVICE FOR AUTOMOBILE

(75) Inventor: Sang Young Lee, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: Kia Motors Corporation, Seoul (KR)

(21) Appl. No.: 12/184,107

(22) Filed: Jul. 31, 2008

(30) Foreign Application Priority Data
Mar. 25, 2008 (KR) 10-2008-0027260

(51) Int. Cl. E05B 57/00

(52) U.S. Cl. 70/141

(57) ABSTRACT

The present invention relates to a direct connecting type door latch device for an automobile, comprising: a key cylinder which is provided at an outside of a door and to which a key operation rod is formed, a latch comprising a connection member, wherein a latch linking means interconnects the key operation rod and the connection member such that the rotation force of the key operation rod of the key cylinder can be transmitted to the connection member of the latch when an outside handle to which the key cylinder is mounted is positioned apart by a predetermined distance from the latch.

### CROSS-REFERENCE TO RELATED APPLICATION

This application claims priority to and the benefit of Korean Patent Application No. 10-2008-0027260 filed in the Korean Intellectual Property Office on Mar. 25, 2008, the entire contents of which are incorporated herein by reference.

### BACKGROUND OF THE INVENTION

(a) Field of the Invention

The present invention relates to a direct connecting type door latch device for an automobile. More particularly, the present invention relates to a direct connecting type door latch device for an automobile in which a key cylinder direct connecting type (direct connecting type) can be applicable to a key cylinder rod type (non-direct connecting type.

(b) Description of the Related Art

Generally, a door-lock of an automobile is a device for locking a door for safety during driving and for prevention of theft, and is provided with a door handle and a door latch so as to be able to be opened and closed at an inside and an outside respectively.

An outside handle and a key cylinder are provided at an outside of a door so as to regulate closing and opening from outside by inserting a door key into the key cylinder, and an inside handle and a knob are provided at an inside of a door so as to regulate closing and opening from inside.

If the key cylinder and the knob of the door latch are regulated to a locking state, a door handle and a latch is disengaged so that the latch is not operated even when the outside handle or the inside handle is operated so that the door cannot be opened or closed.

In contrast if the key cylinder and the knob are released from the locking state, the door handle and the latch are engaged to one another so that the latch operates by the operation of the outside handle or the inside handle so that the door can be opened or closed.

Meanwhile, generally, the door latch device can be divided into a key cylinder direct connecting type (direct connecting type) and a key cylinder rod type (non-direct connecting type). The key cylinder direct connecting type which directly connects a latch of a door and thus have a simplified connecting structure and a key cylinder in single body makes up for disadvantage of a key cylinder rod type having problem of theft.

In the key cylinder direct connecting type, an operation rod which rotates simultaneously with the rotation of a key cylinder is provided at a rear side of the key cylinder which is mounted to an outside handle of a door, a key insertion hole to which an end of the operation rod is coupled is formed at a latch, and a knob which operates during the rotation of the operation rod so as to lock or release the latch.

That is, if a key is inserted into the key cylinder and the key cylinder is rotated, the transmitted rotation force rotates the knob through the operation rod, and the latch is locked or released depending on rotation direction of the knob.

However, in a door latch device which is formed in a conventional key cylinder direct connecting type, the key insertion hole is formed integrally in the latch, and on the other hand, the key cylinder and the operation rod are mounted to the outside handle, so that the key cylinder direct connecting type cannot be adopted in case that the outside handle and the latch are far from each other.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide a direct connecting type door latch device for an automobile which a latch linking means which is formed in a link structure links an operation rod and a key insertion hole so that the operation of the key can be transmitted to the latch even through an outside handle is located at any positions, in case that the outside handle is apart from the latch so that the key insertion hole and the key cylinder are not directly connected to one another.

An exemplary embodiment of the present invention provides a direct connecting type door latch device for an automobile including: a key cylinder which is provided at a door and to which a key operation rod is formed, the key cylinder rotating in a rotation direction of a key in case the key inserted into the key cylinder is rotated; and a latch comprising a connection member, wherein the latch locking or unlocking a door striker is coupled to the key cylinder locking or unlocking the door, by a latch linking means through the connection member of the latch such that rotation force of the key operation rod can be transmitted to the latch when an outside handle to which the key cylinder is mounted is positioned apart by a predetermined distance from the latch.

The latch linking means may comprise: a lever wherein first end portion of the lever is configured to be inserted into the connection member of the latch and is rotatable therein and second end portion of the lever is formed in a bar shape having a predetermined length from a rotation axis of the lever; a link rod which is coupled to the second end portion of the lever so that the lever can rotate in response to rotation of the key operation rod; and a link arm which interconnects the key operation rod and the link rod so as to convert the rotation of the key operation rod into ascending and descending movements of the link rod in response to operations of the key operation rod.

The operation directions of the link arm and the lever may be opposite to each other or in another exemplary embodiment of the present invention, operation directions of the link arm and the lever may be the same.

The second end portion of the lever may further comprise a guide link wherein the guide link covers a lower portion of the link rod where the link rod and the lever are coupled so as to prevent the link rod from leaving apart from the lever of the latch.

In further another exemplary embodiment of the present invention, a direct connecting type door latch device for an automobile, may comprise: a key cylinder which is provided at a door and to which a key operation rod is formed, the key cylinder rotating in a rotation direction of a key in case the key inserted into the key cylinder is rotated; and a latch comprising a connection member, wherein the latch locking or unlocking a door striker is coupled to the key cylinder locking or unlocking the door by a latch linking means through the connection member of the latch such that rotation force of the key operation rod of the key cylinder can be transmitted to the latch when an outside handle to which the key cylinder is mounted is positioned apart by a predetermined distance from the latch, wherein the latch linking means comprises: a lever wherein first end portion of the lever is configured to be inserted into the connection member of the latch and is rotatable therein and second end portion of lever is formed in a bar shape having a predetermined length from a rotation axis of the lever; a link rod which is coupled to the second end portion of the lever so that the lever can rotate in response to rotation of the key operation rod; and a link arm which interconnects the key operation rod and the link rod so as to convert the rotation of the key operation rod into ascending and descending movements of the link rod in response to operations of the key operation rod, wherein the second end portion of the lever further includes a guide link covering a lower portion of the link rod where the link rod and the lever are coupled together so as to prevent the link rod from leaving apart from the lever of the latch.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view of a direct connecting type door latch device for an automobile according to an embodiment of the present invention;

FIG. 2 is a perspective view showing a state of connection of a direct connecting type door latch device for an automobile according to an embodiment of the present invention and an outside handle; and

FIG. 3A and FIG. 3B show a locking or an unlocking operation state of a direct connecting type door latch device for an automobile according to an embodiment of the present invention.

In the figures, reference numbers refer to the same or equivalent parts of the present invention throughout the several figures of the drawing.

<Description of Representative Reference Numerals>

| | |
|---|---|
| 10: latch linking means | 11: key lever |
| 12: link rod | 13: link arm |

### DETAILED DESCRIPTION OF THE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

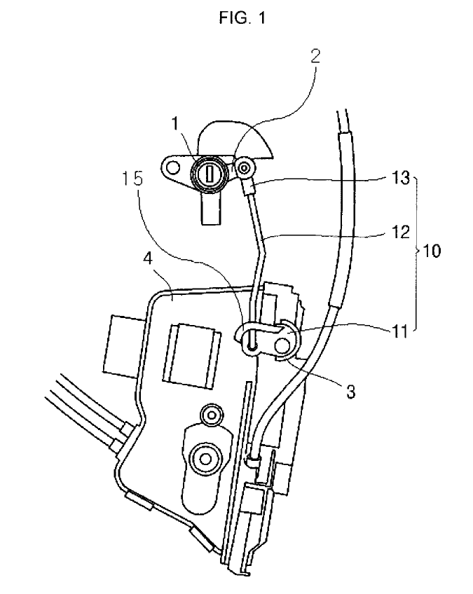

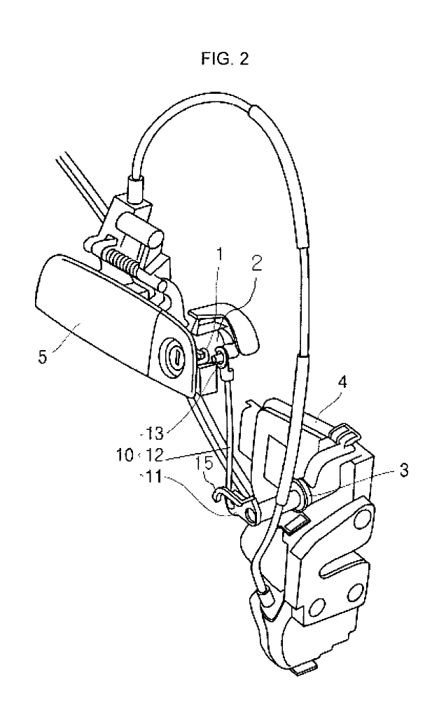

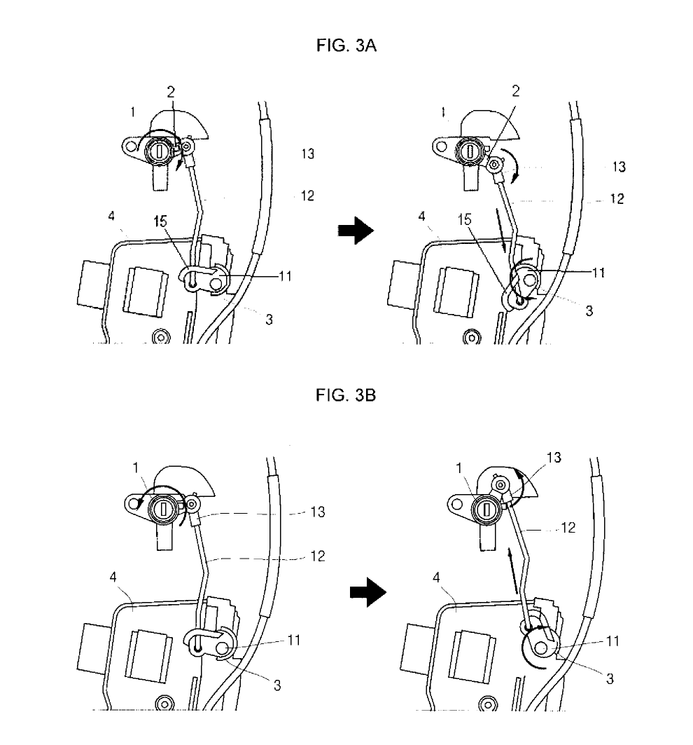

FIG. 1 is a perspective view of a direct connecting type door latch device for an automobile according to an embodiment of the present invention, FIG. 2 is a perspective view showing a state of connection of a direct connecting type door latch device for an automobile according to an embodiment of the present invention and an outside handle, and FIG. 3A and FIG. 3B show a locking or unlocking operation state of a direct connecting type door latch device for an automobile according to an embodiment of the present invention.

As shown in the drawings, a key cylinder 1 is coupled to a side of an outside handle 5, and is coupled to an outer panel (not shown) of the vehicle and thus a portion of the key cylinder 1 is exposed to an outside of a door in a state of being coupled to the outside handle 5.

A key operation rod 2 which rotates together with rotation of the key cylinder 1 is coupled to rear side of the key cylinder 1, and the key operation rod 2 is protruded backwards substantially in a straight line.

A latch 4 comprising a connection member 3 and a lever 11 is provided in the vehicle. However, the outside handle 5 to which the key cylinder 1 is coupled is spaced apart by a predetermined distance from a latch 4.

In this configuration, the key operation rod 2 of the key cylinder 1 is not directly connected with the connection member 3 of the latch 4 but coupled by a latch linking means 10 which couples the key operation rod 2 of the key cylinder 1 with the connection member 3 of the latch 4 as an intermediary medium.

As an exemplary embodiment, the latch linking means 10 includes the lever 11 of the latch 4, a link rod 12, and a link arm 13.

One end of the lever 11 is configured to be inserted into the connection member 3 of the latch 4 and is rotatable therein. Other end of the lever 11 is formed of a link having a predetermined length and spaced from rotation axis of the lever 11.

One end of the link arm 13 is pivotally coupled to an end of the key operation rod 2.

The link rod 12 pivotally is coupled to other end of the lever 11 and other end of the link arm 13, wherein the link arm 13 pivotally converts rotation of the key operation rod 2 into ascending and descending movements of the link rod 12 in response to operations of the key cylinder I. The transmitted ascending and descending movements of the link rod 12 is converted into rotation of lever 11 coupled to the latch 4 via the connection member 3 so that the door can be opened or closed outside.

Meanwhile, the latch 4 further is configured to be locked or unlocked by a knob which is provided to an inner panel of the door so that the door can be opened or closed at an inside room of an automobile.

Operations of a direct connecting type door latch device for an automobile according to an embodiment of the present invention will be explained hereinafter with reference to FIG. 3A and FIG. 3B.

Firstly, the locking state of the door will be explained.

As shown in FIG. 3A, in case that a key is inserted into the key cylinder 1 and rotated clockwise in the drawing, the link arm 13 pivotally coupled to the key operation rod 2 rotates clockwise with the rotation of the key cylinder 1, and thus the link rod 12 one end of which is connected to the link arm 13 descends.

At the same time, the lever 11 of the latch 4 which is coupled to the link rod 12 rotates counterclockwise, that is, in a direction for locking the latch 4 of the door so that the door is locked.

The unlocking state of the door will be explained.

As shown in FIG. 3B, in case that a key is inserted into the key cylinder 1 and rotated counterclockwise in the drawing, the link arm 13 which is pivotally coupled to the key operation rod 2 rotates counterclockwise with rotation of the key cylinder 1, and thus the link rod 12 one end of which is connected to the link arm 13 ascends.

At the same time, the lever 11 which is coupled to the link rod 12 rotates in a clockwise, that is, in a direction for unlocking the latch 4 of the door so that the door is unlocked.

If the locking state is released as such, the latch 4 can be released from a striker (not shown) by manipulation of the outside handle 5 so that the door can be opened.

Although the operation directions of the link arm 13 and the lever 11 are opposite to each other in the instant embodiment of the present invention, the operation directions thereof may be the same through structure changes in design at an exemplary embodiment.

Accordingly, the present invention is provided with the latch linking means such that the key cylinder direct connecting type in which the key cylinder and the key insertion hole are directly connected to each other can be applicable to the key cylinder rod type, so the present invention provides a new direct connecting type door latch device for an automobile in which the operation of the key can be transmitted to the latch even though the outside handle is located at any positions so that the key cylinder direct connecting type can be adopted to all the outside handles in common, and thus it can be widely used and convenience and economical efficiency in an automobile design can be enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A direct connecting type door latch device for an automobile door, comprising:
a key cylinder disposed on the door, the key cylinder rotating in a rotation direction of a key in case the key inserted into the key cylinder is rotated;
a key operation rod extending from the key cylinder for rotation therewith; and
a latch comprising a connection member, wherein the latch locking or unlocking a door striker is coupled to the key cylinder locking or unlocking the door by a latch linking means through the connection member of the latch such that rotation force of the key operation rod can be transmitted to the latch when an outside handle to which the key cylinder is mounted is positioned apart by a predetermined distance from the latch.

2. The direct connecting type door latch device of claim 1, wherein the latch linking means comprises:
a lever wherein first end portion of the lever is configured to be inserted into the connection member of the latch and is rotatable therein and second end portion of the lever is formed in a bar shape having a predetermined length from a rotation axis of the lever;
a link rod which is coupled to the second end portion of the lever so that the lever can rotate in response to rotation of the key operation rod; and
a link arm which interconnects the key operation rod and the link rod so as to convert the rotation of the key operation rod into ascending and descending movements of the link rod in response to operations of the key operation rod.

3. The direct connecting type door latch device of claim 2, wherein operation directions of the link arm and the lever are opposite to each other.

4. The direct connecting type door latch device of claim 2, wherein operation directions of the link arm and the lever are the same.

5. The direct connecting type door latch device of claim 2, wherein the second end portion of the lever further comprises a guide link wherein the guide link covers a lower portion of the link rod where the link rod and the lever are coupled so as to prevent the link rod from leaving apart from the lever of the latch.

6. A direct connecting type door latch device for an automobile, comprising:
a key cylinder which is provided at a door and to which a key operation rod is formed, the key cylinder rotating in a rotation direction of a key in case the key inserted into the key cylinder is rotated; and
a latch comprising a connection member, wherein the latch locking or unlocking a door striker is coupled to the key cylinder locking or unlocking the door by a latch linking means through the connection member of the latch such that rotation force of the key operation rod of the key cylinder can be transmitted to the latch when an outside handle to which the key cylinder is mounted is positioned apart by a predetermined distance from the latch,
wherein the latch linking means comprises:
a lever wherein first end portion of the lever is configured to be inserted into the connection member of the latch and is rotatable therein and second end portion of lever is formed in a bar shape having a predetermined length from a rotation axis of the lever;
a link rod which is coupled to the second end portion of the lever so that the lever can rotate in response to rotation of the key operation rod; and
a link arm which interconnects the key operation rod and the link rod so as to convert the rotation of the key operation rod into ascending and descending movements of the link rod in response to operations of the key operation rod,
wherein the second end portion of the lever further includes a guide link covering a lower portion of the link rod where the link rod and the lever are coupled together so as to prevent the link rod from leaving apart from the lever of the latch.
